(19) United States
(12) Patent Application Publication
(10) Pub. No.: US 2003/0157702 A1
(43) Pub. Date: Aug. 21, 2003

(54) Composting system

(76) Inventor: Archie Bard, Santa Barbara, CA (US)

Correspondence Address: KENNETH J. HOVET, NORDMAN, CORMANY, HAIR & COMPTON, P.O. BOX 9100, OXNARD, CA, 93031-9100, US

(21) Appl. No.: 10/369,787

(22) Filed: Feb. 19, 2003

Related U.S. Application Data
(60) Provisional application No. 60/359,166, filed on Feb. 21, 2002.

(51) Int. Cl. C05F 11/08

(52) U.S. Cl. 435/290.4; 71/9

(57) ABSTRACT

A U-shaped flexible tray for a compost bin having a rear wall, a front wall and a floor. The ends of the front and rear walls are releasably attached to upstanding mounting posts. Organic material is deposited into the bin and aerated, thereby forming compost. A tarp cover protects the compost from wind and rain. A forced air system beneath the bin forces air through the organic matter to promote composting. The composted product is unloaded by a bin emptying device having an upper roller that draws the rear wall forward, and a lower roller that draws the front wall forward, thereby shifting the weight of the compost. As the rollers tighten, the flexible tray is transformed from a U-shaped bin into a vertical wall, thereby moving the compost out of the bin. The flexible tray is then manually restored to its original mounting posts and the U-shape restored. The bin emptying device may advance on tracks to the next designated bin to resume emptying operations.

This application claims priority from U.S. Provisional Patent Application No. 60/359,166 entitled “COMPOSTING SYSTEM,” filed on Feb. 21, 2002.

### BACKGROUND OF THE INVENTION

1. Field of the Invention

The present invention pertains generally to a system for composting organic material. Its main advantages arise from the ability to control the composting process with a minimum of operating costs and relatively low capital investment to produce a uniform, high-quality product. It has the ability to handle very large or small volumes of material. It has particular relevance to the organic waste recycling business, wastewater treatment operations and to the mushroom business.

2. Description of Related Art

Agricultural endeavors such as mushroom harvesting have long relied on composting to produce healthy and fertile soil. Composting involves taking organic matter and placing it in a “pile” that is then decomposed by bacteria into elemental soil-type material. The large volume of matter used in composting lowers the surface to volume ratio, thereby limiting both heat escape, and moisture escape. This serves to maintain an environment conducive for the bacteriological breakdown of the organic matter.

In the past, composting has been performed in large piles that can weigh upwards of several tons, even upwards of tens or hundreds of tons. The management of such large masses is problematic. Even when forced air is used for aeration, as a compost pile increases in size, it is harder and harder to insure that air or moisture will be evenly distributed through the mass. As a result, one region within a large mass may be well reduced to compost matter, whereas another region remains largely uncomposted.

The handling of massive compost piles is equally problematic. Manual labor using shovels and tools is labor intensive and, therefore, both expensive and inefficient. The capital investment for earth moving machines can also be significant, and the operation of such machines cumbersome.

In view of the above, a need exists for a composting system that can handle massive quantities of organic material in workable sizes. There is further a need for a composting system that insures more even aeration and hydration. There is also a need for an efficient system for selecting and capturing a predetermined amount of compost matter from a compost mass.

### SUMMARY OF THE INVENTION

The present invention is directed to a composting system that can parcel massive quantities of organic material into workable sizes. In this way, the system ensures more even aeration and hydration. Additionally, an efficient system for selecting and capturing a predetermined amount of compost matter from a compost mass is provided.

Still further, a method of managing compost material is disclosed that utilizes a flexible tray having a first end, a second end, and an air permeable mesh between the first and second end. The method comprises the steps of supporting the first end of the flexible tray from a first support unit, thereby forming a first side of an operational bin; supporting the second end of the flexible tray from a second support unit, thereby forming a second side of the operational bin; flexing the flexible tray such that a bin floor is formed by a portion of the flexible tray disposed between the first end and the second end of the flexible tray, wherein the floor comprises a portion of the air permeable mesh. A plane defined by the floor intersects planes defined by the first and second side.

A volume of organic material is deposited from a large source of organic material into the operational bin. The volume of organic material is aerated within the operational bin and the organic material is substantially converted into compost. The first end of the flexible tray is then moved through a motion that comprises a horizontal component of motion in the direction of the second end; and the compost material is discharged from the operational bin.

The step of moving the first end of the flexible tray advantageously comprises the steps of coupling the first end of the flexible tray to an upper grasping member of a tray emptying device wherein the upper grasping member is coupled to an upper tension member; winding the upper tension member on an upper roller of the tray emptying device; releasing the first end of the flexible tray from the first support unit; and winding a portion of the flexible tray onto the upper roller.

According to one embodiment, the second end of the flexible tray is coupled to a lower grasping member of the tray emptying device. The lower grasping member is coupled to a lower tension member, and the lower tension member is wound onto a lower roller. A portion of the flexible tray can also be wound onto the lower roller.

The operational bin is advantageously part of a bin complex that includes a previously used bin. According to another embodiment, the tray emptying device may be moved from a previous bin to an adjacent operational bin, and the operational bin may be moved to a position proximate the tray emptying device. In another embodiment, the system provides for progressively shifting the weight of the compost within the first bin onto a ramp prior to the step of discharging the compost from the operational bin.

The compost managing system further comprises a plurality of bins including a first bin having a front wall, a rear wall and a floor formed from a single flexible tray. The front wall includes a first coupling member at a top of the wall, and the rear wall includes a second coupling member at a top of the rear wall. A front support functions to support the front wall in an upright position and a rear support functions to support the rear wall in an upright position.

An aeration means comprises a forced air source for moving air into air supply ducts in fluid communication with air outlets disposed under the floor of the first bin. A tray emptying device for removing compost material from the first bin includes a first roller apparatus comprising a first drum roller coupled to a fixed end of a first tension member and a first gripping means coupled to a free end of the first tension member. The first gripping means is configured to grip the first coupling member attached to the top of the front wall.

A second roller apparatus comprising a second drum roller is coupled to a fixed end of a second tension member, and a second gripping means is coupled to a free end of the second tension member. The second gripping means engages the second coupling member which is attached to the top of the rear wall. The first roller apparatus is configured to wind the first tension member around the first drum roller and the second roller apparatus is configured to wrap the second tension member around the second drum roller. The first drum is advantageously at a higher elevation than the second drum.

In an alternative embodiment of the invention, the first coupling member comprises an S-hook, and the first coupling member comprises a rigid rod.

The tray emptying device advantageously comprises a ramp forming a bottom of the tray emptying device. The second drum is configured to move a portion of the flexible tray onto the ramp. The first roller apparatus may include a motor for driving the first drum roller or a manual member for driving the first drum roller. A bin cover may be used above the first bin. A transit mechanism may also be provided to move the tray emptying device from bin to bin.

### BRIEF DESCRIPTION OF THE DRAWINGS

The novel features of this invention will be best understood from the accompanying Figures, taken in conjunction with the accompanying description, in which similar characters refer to similar parts, and in which:

FIG. 1 is an isometric view of the composting system of the present invention.

FIG. 2 is a top plan view of a flexible tray for the system of FIG. 1.

FIG. 2A is a top plan view of an alternative embodiment for the tray of FIG. 2A.

FIG. 3 is a rear elevational view of a bin of the system of FIG. 1, which shows the manner in which forced air is introduced into each bin.

FIG. 3A is a side elevational view of the bin of FIG. 3, which shows the manner in which a tarp can be optionally placed over the bin.

FIG. 4 is an isometric view of the tray emptying device for the system of FIG. 1.

FIG. 5 is side elevational view of the system of FIG. 1 during the initial stages of offloading the contents of a composting bin.

FIG. 6 is the same view as FIG. 5 during the approximate mid-point of the offloading operation.

FIG. 7 is the same view as FIG. 5 during the approximate endpoint of the offloading operation.

FIG. 8 is a top plan view of the composting pallet of FIG. 1, with portions removed for clarity.

FIG. 9 is a cross-sectional view as seen along lines 9 - 9 in FIG. 8.

FIG. 10 is an isometric view of a saddle that is used in conjunction with the flexible tray of FIG. 2A.

### DESCRIPTION OF THE PREFERRED EMBODIMENTS

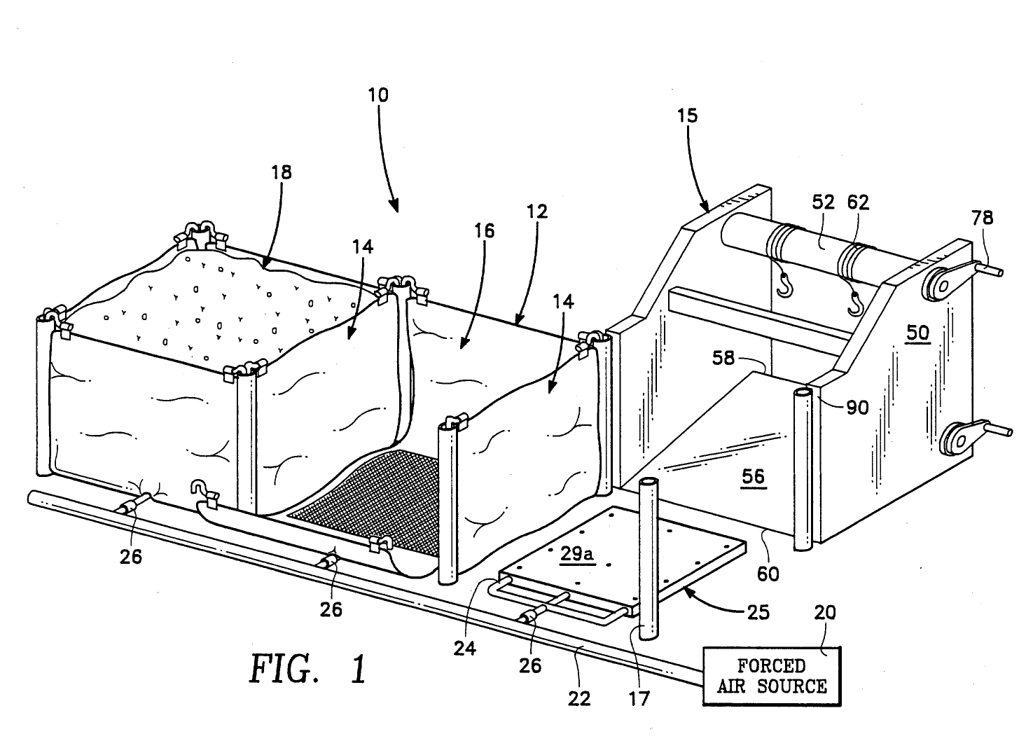

Referring now to the Figures, the high volume composting system is shown and is generally designated by reference character 10. In brief overview, the system comprises a plurality of flexible trays 12 which each rest upon a respective compost pallet 25, a plurality of spaced-apart, hollow post uprights 17 to support the flexible trays and a plurality of evenly spaced-apart bin separation walls 14. The bin separation walls, which are preferably made of a heavy-duty fabric or plywood material, extend between the post uprights on each side of a respective flexible tray and are fixed to the post uprights. Alternatively, the bin separation walls can be made of a heavy canvas material and attached to the post uprights with S-hooks 44 as described below. The flexible tray, post uprights and separation walls cooperate to define a plurality of compost bins 16, as shown in FIG. 1.

As shown in the Figures, the system includes a tray emptying device 15. The tray emptying device facilitates offloading of each compost bin in a manner hereinafter described. With the above structure, large aggregate amounts of compost 18 can be divided into smaller, more manageable amounts that are defined by the volume of the bin. This allows for a more controlled manipulation of the composting process in a manner more fully described below.

To aerate the compost 18 in each bin, thereby facilitating the composting process, the composting system of the present invention includes a forced air source 20. A main air supply duct 22 is connected to the forced air source to supply pressurized air to the underside of each bin. Such forced air source provides the system with the capacity to not only oxygenate the compost therein, but also provides the capability to control the temperature within the compost mass, for maximum control over the overall composting process. The air may also be directed down through the compost versus being directed upwardly through the compost. This system provides the flexibility to operate in either mode.

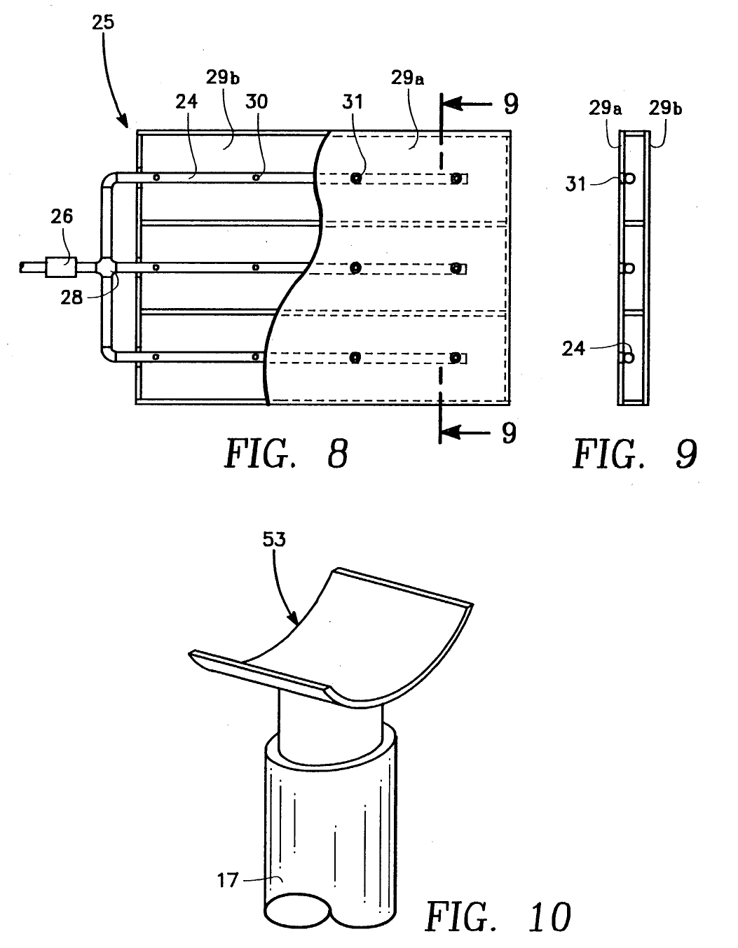

For each bin, and referring now primarily to FIGS. 1, 8 and 9, each bin includes a corresponding composting pallet 25 that is connected to the main air supply duct at a quick disconnect fitting 26 in a manner known in the art (the quick disconnect fitting 26 is optional). As shown in FIG. 8, the pallet includes an upper board 29a and a spaced-apart lower board 29b (optional), that lie in horizontal planes that are about parallel to each other. A plurality of connector ducts 24 branch off from junction 28 and extend into the pallet and are fixed to the bottom of the upper board 29a.

Each connector duct is formed with a plurality of air holes 30, and the upper board is formed with a plurality of corresponding pallet openings which are aligned with the air holes 30, as best seen in FIG. 8. With this configuration, a flow path for air from the forced air source is established through the main air supply duct, connector ducts, through the air holes and pallet openings and into the bin when the composting pallet is placed in the bin. Once the flexible tray is positioned on the bin as described below, and the bin is filled with compostable materials, the forced air infiltrates the material and facilitates the composting process in the bin by aerating the compost 18 therein. Monitoring devices may be incorporated into the air system to allow automatic control of the environment within the compost.

For the materials of the present invention, and as mentioned above, the bin separation walls are preferably made of flexible plastic or plywood, but other inexpensive materials with similar strength properties for providing structural support could also be used. The main air supply duct can be made from either flexible or rigid material. The connector ducts are preferably made of a plastic material such as polyvinyl chloride (PVC), although other similar types of materials with high strength-to-weight ratios are also envisioned.

As illustrated in FIG. 1, the tray emptying device 15 is “in front” of a selected bin 16 scheduled for unloading, depending on how one chooses to designate the “front” and “back” of a bin. Because each tray emptying device is costly, it is advantageous to have a single tray emptying device that can service an array of bins 16 as illustrated in FIG. 1. This can be accomplished either by moving the tray emptying device to a destination bin, moving the bin array with respect to the tray emptying device 15, or moving both the bin and the emptying device.

However, embodiments are envisioned wherein the aeration system is embedded in concrete below the respective bins, or, at the very least, affixed to the ground. The network of aeration and piping tends to make the bin array less mobile, and the prospect of moving a bin array problematic. According to the preferred embodiment, therefore, the array of bins remains fixed while the tray emptying device 15 transits from bin to bin. Transiting the tray emptying device 15 can be accomplished by any known means, including wheels, raising the tray emptying device 15 by compressed air, fork lifts, jacks and the like. The motion of the tray emptying device can be free, or it can be guided by tracks. The array of bins 16 is preferably a linear array, as illustrated in FIG. 1, thereby facilitating an efficient movement of the tray emptying device 15 from bin to bin.

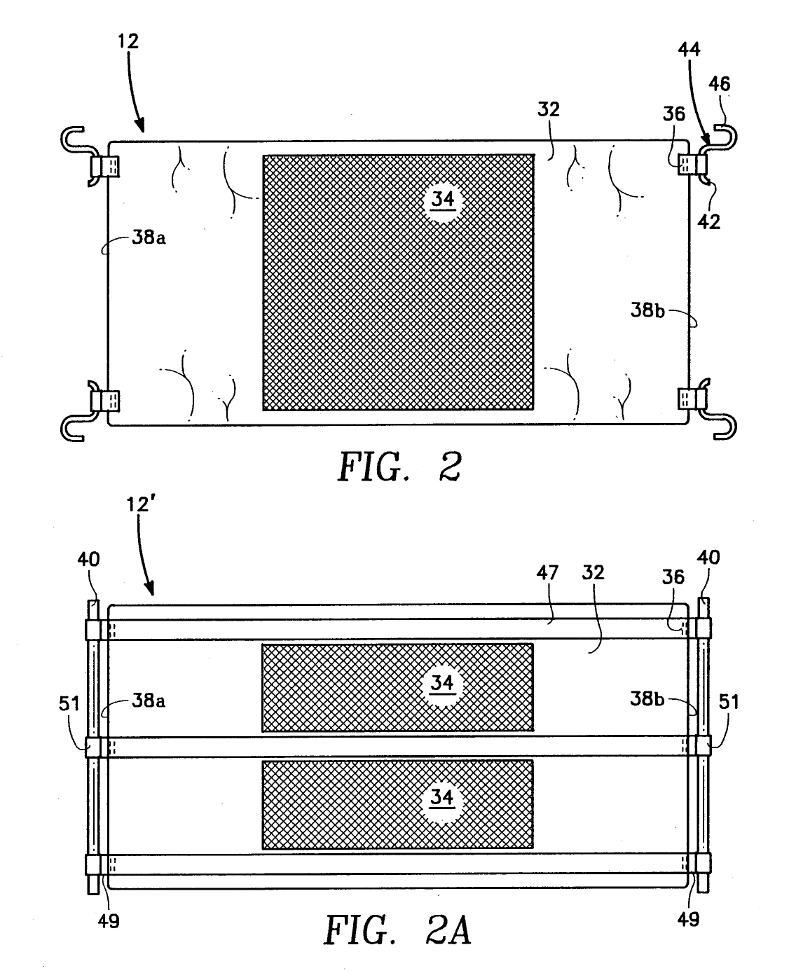

Referring now primarily to FIG. 2, the flexible tray 12 comprises a sheet 32 that, when laid flat, is rectangular is shape (other polygonal shapes could also be used) and comprises a mesh portion 34 (which allows air to move into the compost) which is roughly centered on the sheet, and this represents the tray bottom. Preferably, the sheet is made of a reusable high tensile strength material, such as a heavy-duty canvas, or an industrial plastic material. A plurality of lifting eyes 36 are attached to opposite ends 38a, 38b proximate the corners of the sheet so that the lifting eyes on end 38a extend in the opposite direction from the lifting eyes on opposite end 38b of the sheet.

To allow for placement on or removal of the tray from the bin, a respective S-hook 44 is attached to each lifting eye. More specifically, the first end 42 of S-hook 44 is passed through the lifting eye. Second end 46 of each S-hook is then placed in a respective post upright 17 (See FIG. 1) to suspend the flexible tray in the bin. Although not shown in the Figures, another pair of lifting eyes could be located in the transverse center of each end 38a, 38b of the sheet. Then, once the bin is filled, a belt (not shown) or similar device would connect the two middle lifting eyes to firmly cinch up the filled tray. An alternative would have a plurality of belts (not shown) which would be attached to the lifting eyes on each tray end so that the tray would be separated from any attachment to the post uprights.

It is to be appreciated that the lifting eye structures could also be attached to the bin separation walls 14, and that the S-hook could be passed through the lifting eye and the opposite top corners of the bin separation walls could then be hung on the post uprights as recited to “hang” the bin separation walls between a front and rear post upright. This allows for more flexibility in the construction of the system if plywood is not immediately available.

Flexible tray 12′ is shown in FIG. 2A as an alternative embodiment of the invention. Tray 12′ includes plurality of longitudinal pockets 47 that are sewn into the sheet. This would allow for use of high tensile strength webbing slings 49 to be threaded through each pocket. Each webbing sling 49 terminates at a pair of opposing webbing eyes 51.

To allow for placement on or removal of tray 12′ from the bin, a respective support pipe 40 is passed through webbing eyes 51 on each end 38a, 38b of the sheet so that the support pipe(s) are oriented parallel to and proximate the ends of the sheet. A saddle 53 is placed in each corresponding post upright 17 (See FIG. 10), and the support pipe is placed on a pair of corresponding saddles. In similar fashion to tray 12, once in place, tray 12′ hangs from the support pipes so that the solid end portions define the front and rear walls of the bin and mesh portion 34 defines the floor of the bin.

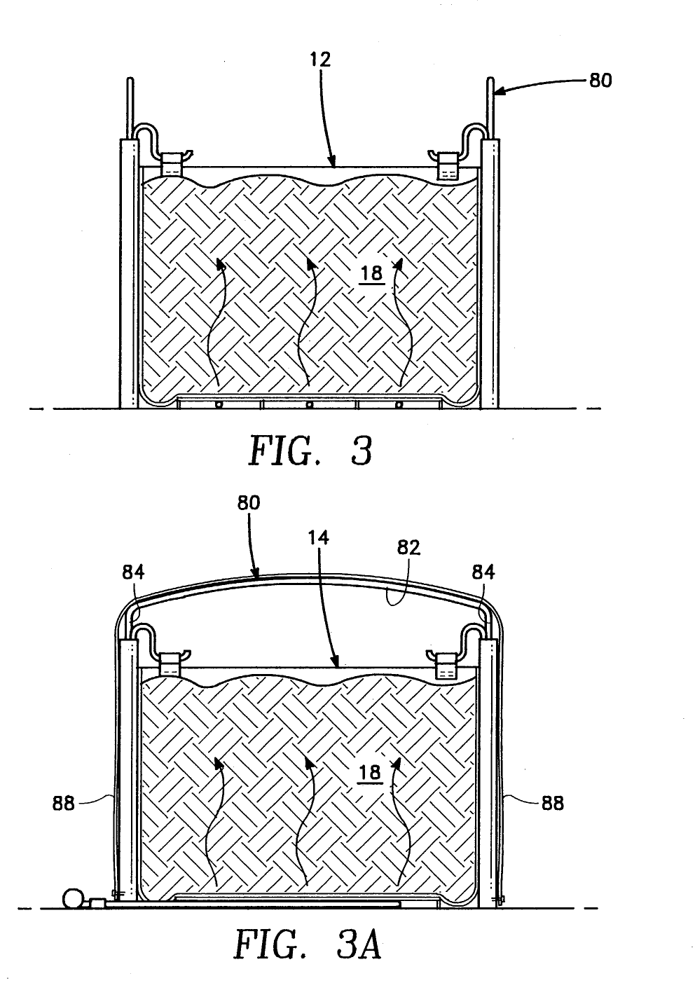

As shown in FIGS. 3 and 3A, the system of the present invention includes a plurality of roof joists 80 which can be either portable or fixed. Each roof joist comprises a center arched portion 82 which merges into spaced apart vertical portions 84, 84 that are parallel to each other. To temporarily fix the roof joist over a bin, the vertical portions are inserted into corresponding post uprights so that the roof joist is oriented front-to-rear when viewed in top plan and is about co-planar with a bin separation wall.

Several roof joists may be placed over a bin so that the arched portions have a parallel spaced-apart relationship with each other. A protective bin covering, shown as tarp 88, can then be placed over the arched portions of the roof joists and attached to tie-down straps (not shown), stakes, bungee cords, or other means known in the art to shelter the compost within the bin. This ensures that the compost in each bin can be protected from wind, sun and rain, which is essential for producing a quality compost. The tarp also provides additional insulation for the compost which ensures proper environmental control of the composting process, especially during cold weather.

When the tarp is in position over the bin(s), the air space above the compost and below the tarp 88 can be directed via fans (not shown) or other similar means known in the art and passed through a bio-filter (not shown) for control of odors.

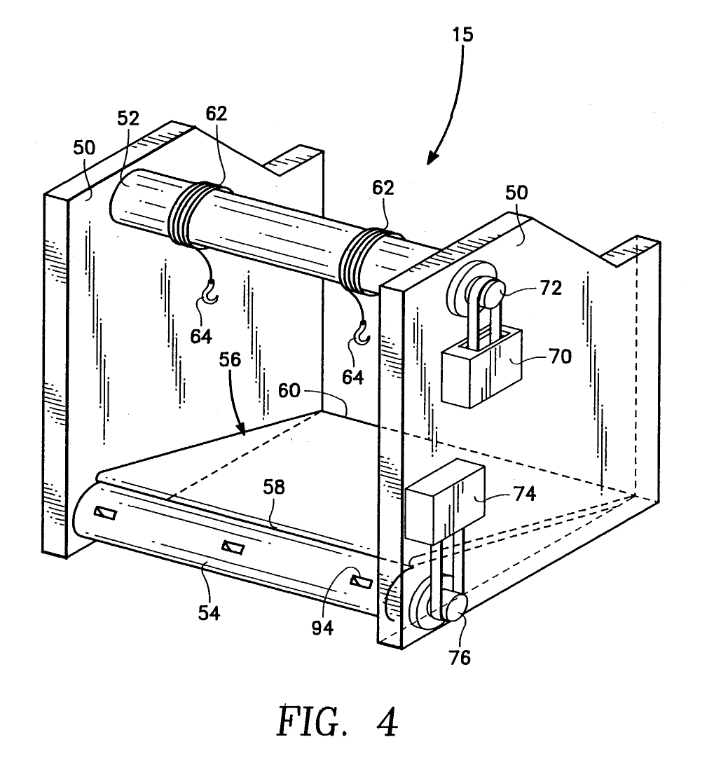

Referring now to FIGS. 1 and 4, the system of the present invention includes a tray emptying device 15 to facilitate offloading of the compost after the composting process is complete. Such tray emptying device comprises a pair of spaced-apart side walls 50, 50. An upper drum roller 52, supported by an axle 72, is rotatably mounted between the side walls 50, so that it rotates freely between trailer walls 50. Similarly, lower drum roller 54, supported by axle 76, is rotatably mounted between the side walls 50, 50. A ramp 56 is positioned between the side walls and is affixed thereto so that leading edge 58 of the ramp is above the lower roller and the trailing edge 60 of the ramp is about even with the bottom portion of the forward vertical edge 90 of the side walls 50, 50 which are placed immediately adjacent the post uprights of the particular tray to be unloaded. This arrangement is best seen in FIGS. 4 and 5-7.

A pair of upper cables 62 are spooled around the upper roller 52 and each upper cable terminates at free-hanging upper hook 64. The lower drum roller 54 does not require cables, as the leading edge of the flexible tray flap closest to the unloading will simply be placed down onto the ramp 56 and be attached to the lower drum roller 54 by inserting the S-hooks or the end of the webbing slings 49, into slots 94 that are formed in the lower roller.

Upper motor 70 is coupled to an end of upper axle 72 that extends past the outer surface of a side wall 50 so that selective operation of the upper motor 70 moves the upper axle 72 (and the upper roller 52 that is fixed thereto). Similarly, lower motor 74 is coupled to lower axle 76, and the lower axle is fixed to lower roller 54, so that operation of lower motor causes lower roller 54 to selectively rotate as desired. Importantly, upper motor and lower motors are selectively operated independently of each other, and can be further operated at different speeds to allow the respective upper roller and lower roller to rotate as desired for maximum efficiency of bin unloading.

The number of upper cables (and associated upper hooks) corresponds to the number of S-hooks or eye hooks fixed to a support pipe. Accordingly, it is to be appreciated that one or any other number of upper cables and upper hooks could be used without departing from the scope of the present invention. It is to be further appreciated, that a hand crank 78 (See FIG. 1) or similar means could also be used in lieu of a motor arrangement to operate the upper and lower rollers, either simultaneously or separately, without departing from the scope of the present invention.

Operation

Initially, tray 12 (or tray 12′) is placed into position by placing S-hooks into the post uprights (or by placing saddles 53 in the post uprights and placing support pole 40 on the saddles) so that the tray and adjacent bin separation walls define a bin as described above. The bin is filled with compostable material via a front loader, feed mix wagon, tilt-bed truck, augers, conveyors, shovels, or other means as known in the art. Air from forced air source 20 is selectively provided to each bin through, in sequence, main air supply duct 22, connector duct, and into the composting pallet 25 for further passage through airholes 30 and pallet openings 31. From pallet openings 31, the air passes through mesh portion 34 and aerates the compost in the bin to thereby facilitate the composting process.

If necessary, roof joists 80 may be placed over the bin by inserting the respective vertical portions into the post uprights as described above, and a plurality of tarps 88 would be draped over the roof joists 80 to cover all of the filled trays. Such tarp(s) would completely envelop the trays and be secured to the ground on both sides of the bin by tiedowns or similar means known in the art. This ensures the composting process in the bin remains aerobic and the compost therein does not dry out or become overly wet. Because the compost tonnage has been manipulated into smaller, more manageable bin volumes, the composting process occurs more quickly than the high volume composting processes of the prior art.

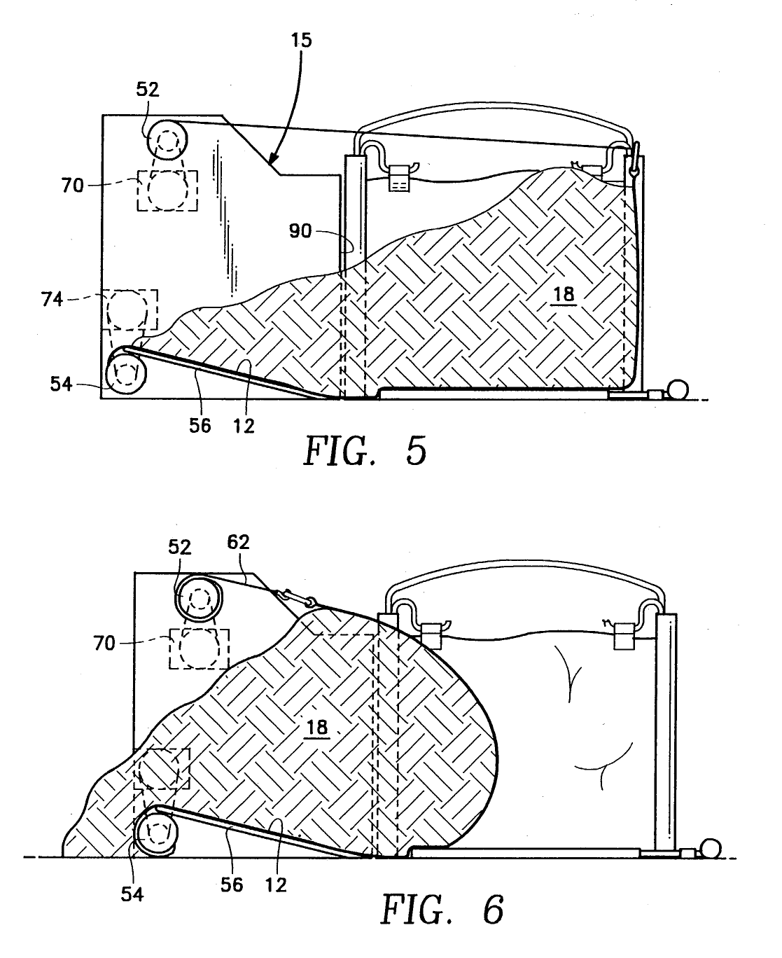

Once the compost in a particular bin is ready for offloading, the tray emptying device is placed next to the rear of the bin so that front edges 90 of the side walls 50 contact the post uprights 17 (See FIGS. 5-7). The rear S-hooks are removed from the post uprights and the rear portion of the tray (the solid portion of the tray that is closest to the tray emptying device) is laid down on the ramp. The S-hooks are inserted into the slots of the lower roller. Simultaneously, the upper hooks are connected to the forward S-hooks of the bin (the S-hooks which are furthest from the tray emptying device), which have been removed from the forward post uprights. This configuration is best seen in FIG. 5.

The lower motor is operated to rotate the lower roller. When this occurs, the lower roller gathers the rear portion of the tray and the flexible tray becomes wrapped around the lower roller.

Independently of the operation of the lower motor as described above, the upper motor is selectively operated, When this occurs, the upper cabling becomes spooled around upper roller 52 and moves the upper hooks toward the upper roller. Since the upper hooks are attached to the forward S-hooks, the S-hooks also move toward the upper roller. This causes the forward portion of the tray (the solid portion of the tray furthest from the tray emptying device) to move toward the tray emptying device. This stage of the operation is best seen in FIG. 6.

The selective operation of the upper motor and lower motor continually shifts the weight of the remaining compost in the bin and positions the remaining compost so that as much of the weight as possible is located on the ramp. This maximizes the mechanical advantage provided by the ramp to move the compost toward the rear of the tray emptying device.

The net effect of the process is to position as much of the weight of the compost to be offloaded as possible onto the ramp during the offloading process. This is accomplished by simultaneously drawing the both ends of the tray horizontally toward the tray emptying device. This allows the system of the present invention to offload compost more efficiently, and less mechanical work is required to offload the compost from systems of the prior art. Thus, one of the main features of this invention involves the concept of volume reduction to facilitate not only composting, but the unloading/emptying process.

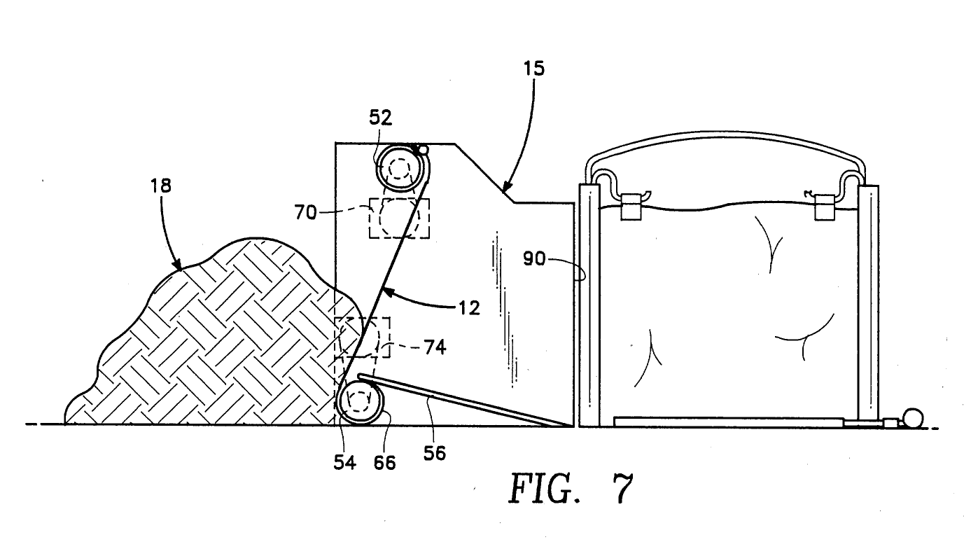

FIG. 7 illustrates the operation of the system during the end stages of the offloading process. As shown, the upper hooks are relatively close to the upper roller and the upper cables are almost entirely wound around the upper roller. Because of the flexible nature of the tray, the tray has also substantially wrapped around the lower roller.

As shown in FIGS. 6 and 7, the compost has been offloaded onto the ground. It is to be appreciated, however, that a conveyor (not shown) or similar device known in the art, could be placed proximate the trailing edge of the ramp. In this way, the compost could be offloaded directly onto the conveyor (or similar device) for packaging and/or further processing.

Another important feature of this system is the ability to provide mixing capability during the unloading operation. This would occur at a point where there is a ninety degree (90°) change in direction of the flow of compost, from its original direction out of the bin and onto the ramp, to a new direction onto a “take-away” conveyor(s) (not shown) that could be positioned perpendicular to the ramp emptying device. Moreover, the selective operation of the upper and lower rollers described above allows the operator to control the offload rate of compost, thereby allowing for introduction of additive(s) or other materials in a more uniform and controlled manner. This adds greatly to the overall utility/flexibility of the system and produces a more uniform compost product of greater quality.

While the high volume composting system, as herein shown and disclosed in detail, is fully capable of obtaining the objects and providing the advantages above stated, it is to be understood that the presently preferred embodiments are merely illustrative of the invention and no limitations are intended therefor.

What is claimed is:

1. A method of managing compost material using a flexible tray comprising a first end, a second end, and an air permeable mesh between the first and second end, the method comprising the steps:
a. supporting the first end of the flexible tray from a first support unit, thereby forming a first side of an operational bin;
b. supporting the second end of the flexible tray from a second support unit, thereby forming a second side of the operational bin
c. flexing the flexible tray such that a bin floor is formed by a portion of the flexible tray disposed between the first side and the second side of the operational bin, wherein the floor comprises at least a portion of the air permeable mesh, and wherein a plane defined by the floor intersects a plane defined by the first side;
d. depositing a volume of compostable material into the operational bin;
e. aerating the volume of compostable material within the operational bin;
f. substantially converting the compostable material into compost;
g. moving the first end of the flexible tray through a motion that comprises a horizontal component of motion in the direction of the second end; and
h. discharging the compost material from the operational bin.

2. The method according to claim 1 wherein the step of moving the first end of the flexible tray comprises the steps:
i. coupling the first end of the flexible tray to an upper grasping member of a tray emptying device wherein the upper grasping member is coupled to an upper tension member;
j. winding the upper tension member on an upper roller of the tray emptying device;
k. releasing the first end of the flexible tray from the first support unit, and
l. winding a portion of the flexible tray onto the upper roller.

3. The method according to claim 2 further comprising the steps:
m. coupling the second end of the flexible tray to a lower grasping member of the tray emptying device wherein the lower grasping member is coupled to a lower tension member; and,
n. winding the lower tension member on a lower roller.

4. The method according to claim 3 further comprising the step of winding a portion of the flexible tray onto the lower roller.

5. The method according to claim 2 further comprising a previous bin, wherein the previous bin and the operational bin form a bin complex, the method further comprising the step of moving the tray emptying device from proximate a previous bin to proximate the operational bin.

6. The method according to claim 2 further comprising a previous bin, wherein the previous bin and the operational bin form a bin complex, the method further comprising the step of moving the bin complex until the operational bin is proximate the tray emptying device.

7. The method according to claim 2 further comprising the step of releasing the flexible tray from the first support unit.

8. The method according to claim 7 wherein the first support unit comprises a plurality of vertical posts, each post comprising a concave saddle member affixed to the top of the respective vertical post, and wherein the first end of the flexible tray comprises a rigid support pipe supported by the plurality of saddles.

9. The method according to claim 7 wherein the first support unit comprises a plurality of vertical posts, and the first end of the flexible tray comprises a plurality of clasping members releasably coupled to the respective plurality of vertical posts.

10. The method according to claim 9 wherein the clasping members are S-hooks.

11. The method according to claim 3 further comprising the step of progressively shifting the weight of the compost within the first bin onto a ramp prior to the step of discharging the compost from the operational bin.

12. A composting system for managing compost material comprising:
a. a bin comprising a flexible material having an air permeable floor from which extends a front wall and a rear wall, the front wall having a first top coupling member, and the rear wall having a second top coupling member;
b. a front support for supporting the front wall in an upright position and a rear support for supporting the rear wall in an upright position;
c. an aeration means comprising a forced air source for moving air into air supply ducts in fluid communication with said floor;
d. a tray emptying device for emptying compost material from said bin, comprising:
i. a first roller apparatus comprising a first drum roller coupled to a fixed end of a first tension member;
ii. a first gripping means coupled to a free end of the first tension member, the first gripping means configured to grip the first coupling member attached to the top of the front wall;
iii. a second roller apparatus comprising a second drum roller coupled to a fixed end of a second tension member;
iv. a second gripping means coupled to a free end of the second tension member, the second gripping means configured to grip the second coupling member attached to the top of the rear wall; wherein the first roller apparatus is configured to wind the first tension member around the first drum roller and the second roller apparatus is configured to wrap the second tension member around the second drum roller.

13. The composting system according to claim 12 wherein the first drum is at a higher elevation than the second drum.

14. The composting system according to claim 12 wherein the first coupling member comprises an S-hook.

15. The composting system according to claim 12 wherein the first coupling member comprises a rigid rod.

16. The composting system according to claim 13 wherein the tray emptying device further comprises a ramp forming a bottom of the tray emptying device, wherein the second drum is configured to drag a portion of the flexible tray onto the ramp.

17. The composting system according to claim 13 wherein the first roller apparatus further comprises a motor for driving the first drum roller.

18. The composting system according to claim 17 wherein the first roller apparatus further comprises a manual member for driving the first drum roller.

19. The composting system according to claim 12 comprising a tarp supported above the first bin.

20. The composting system according to claim 12 comprising a transit mechanism for moving the tray emptying device from proximate the first bin to proximate a second bin.
